(19) United States
(12) Patent Application Publication
(10) Pub. No.: US 2008/0148277 A1
(43) Pub. Date: Jun. 19, 2008

(54) Optimizing calls from a managed runtime environment to microkernel extended functionality

(75) Inventor: Cristiano di Flora, Lempaala (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/640,353

(22) Filed: Dec. 18, 2006

(51) Int. Cl. G06F 13/14

(52) U.S. Cl. 719/313

(57) ABSTRACT

A sequence of function calls may be executed as a single software component, rather than as individual method calls on a operating system, for example, in a microkernel system. Source code from a user application is parsed to identify a plurality of homogeneous function calls, for example, corresponding to sequence of native microkernel method calls. A homogeneous downcall sequence (HDS) is identified in the application source code, and a separate software component (e.g., a native plug-in) is generated to perform the functionality of the HDS. The application code may be modified to remove the plurality of function calls and replace them with a reference to the newly-generated software component. Finally, the modified application code is executed on the server, for example, by a managed runtime environment (MRTE) process. The software component may be invoked and executed as-a-whole by a native process.

### BACKGROUND

Microkernels are computer operating systems that provide only the most basic and essential system functionality in one or more internal microkernel core processes. The so-called microkernel core maintains critical memory and provides essential operating system services, for example, thread management, interprocess communication (IPC), and address space/memory management. The extended functionality of the operating system, that is, the other operating system functionality not included in the microkernel core, is provided by other processes known as external servers. Microkernel external servers typically run in separate processes from the microkernel core, and are executed in user-mode rather than kernel-mode. The external servers may be built on top of the microkernel core and may invoke core methods to receive and respond to client requests, perform their own functionality on the system, and communicate with the other external servers via the core interprocess communication (IPC) functions.

User applications executed on such a system may be executed either as native applications that directly invoke system functions during execution, or managed applications that rely on a managed runtime environment (MRTE), such as the Java runtime, to manage and optimize the execution of the application program on the server. An MRTE will typically access the extended functionality of the microkernel operating system by using downcalls, or native calls to separate stub system libraries that provide the MRTE with system-level functionality. In such systems, an MRTE-Native system interface, such as the Java Native Interface, provides the MRTE with access to the various methods of the microkernel external servers.

When a user application, such as a conventional managed graphical user interface (GUI) application, needs to invoke a system-level service, the MRTE may defer the system calls made by the application to an adapter stub library which issues a request to the microkernel to establish a communication link with the required external server. The MRTE then sends this request to the server, for example, using native operating system IPC. After processing the request, the external server then delivers the results to the adapter library, which can finally call back the invoking MRTE library function to provide the computed results.

Thus, applications running on a MRTE attempting to use the services provided by the underlying microkernel architecture will typically face several levels of indirection, which may increase the overall downcall overhead significantly. The first source of indirection is related to the microkernel architecture, which requires the MRTE to interact with the operating system by means of repeated downcalls to native stub-libraries. This is typically the only mechanism that managed components can use to interact with microkernel extended functionality. Additionally, this may require the MRTE implementation itself to include both native and managed components. Further, since the MRTE and microkernel external servers typically run in different system processes, each downcall requires the operating system to switch the control of the computing device from the MRTE process context to the context of the involved microkernel external server, thus introducing an architecture-dependent context-switching overhead. The amount of context-switching overhead associated with the use of extended functionality in a microkernel system may affect system performance and stability, both for native methods executed directly on the system as well as user applications run on the system.

Moreover, the well-known advantages of providing extended functionality through stub dynamic link libraries (DLLs) has had the effect of encouraging implementation of smaller and more general DLL procedures. Thus, execution of these DLL procedures requires the involved MRTE managed libraries to perform more invocations to the same external server(s). Accordingly, the interaction between a managed code application and a microkernel server is more likely to involve several request-response interactions with the same resource, each of which introduces several context-switching contributions to the overall downcall overhead. Accordingly, there remains a need for systems and methods for efficiently executing sequences of system function calls on an operating system.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a sequence of function calls is executed against a server as a single software component, rather than individually as a sequence of function calls. Initially, the application source code may be received and parsed to identify a plurality of homogeneous function calls. For example, in a microkernel operating system, the homogeneous function calls may correspond to calls invoking the same native microkernel method, or to sequential calls of different methods supported by the same external server. When a homogeneous downcall sequence (HDS) has been identified in the application source code, a separate software component, for example, an executable HDS (EHDS) implemented as a native plug-in, may be generated to perform the functionality of the HDS. The original application code may then be modified so that the plurality of function calls are removed and replaced by a reference to the newly generated software component. Finally, the application code may be executed on the server, for example, by a managed runtime environment (MRTE) process. During the execution of the modified code, the software component may be invoked and executed as-a-whole by a native process, thereby potentially reducing the context-switching overhead for performing the HDS functionality.

According to another aspect of the present disclosure, a microkernel operating system may provide different extended functionality as different external servers (e.g., system processes executing in user-mode rather than kernel-mode). For each external server on the microkernel system, an execution proxy server is established to execute the identified EHDSs. Thus, each EHDS may be executed by sending a single IPC message to the execution proxy server. According to yet another aspect, the executable software components corresponding to the HDS functionality may be stored, for example, in a native DLL repository, and statically or dynamically loaded into the appropriate proxy server for execution.

According to another aspect of the present disclosure, sequences of multiple system calls, for example, native microkernel methods (NMMs), that may be susceptible to replacement by a single EHDS may be identified by an HDS detector process which parses and analyzes the application source code prior to the execution of the code. Specific NMM calls may be identified by comparing the source code to a native microkernel method table stored on the system. Additionally, the control structures of the source code, such as control loops and instances of sequential execution of methods, may be used to identify HDSs. Both native application code and managed application code may be parsed and analyzed for HDSs.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a computing device, in accordance with aspects of the present invention;

FIG. 2 is a component diagram illustrating a computing device running a microkernel operating system, in accordance with aspects of the present invention;

FIG. 3 is a flow diagram showing illustrative steps for executing a sequence of system function calls on a server, in accordance with aspects of the present invention;

FIG. 4 is a flow diagram showing illustrative steps for detecting homogeneous downcall sequences (HDSs) in application code, in accordance with aspects of the present invention; and

FIG. 5 is a schematic block diagram showing software components and component communication in an illustrative system for executing a sequence of downcalls on a microkernel operating system, in accordance with aspects of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

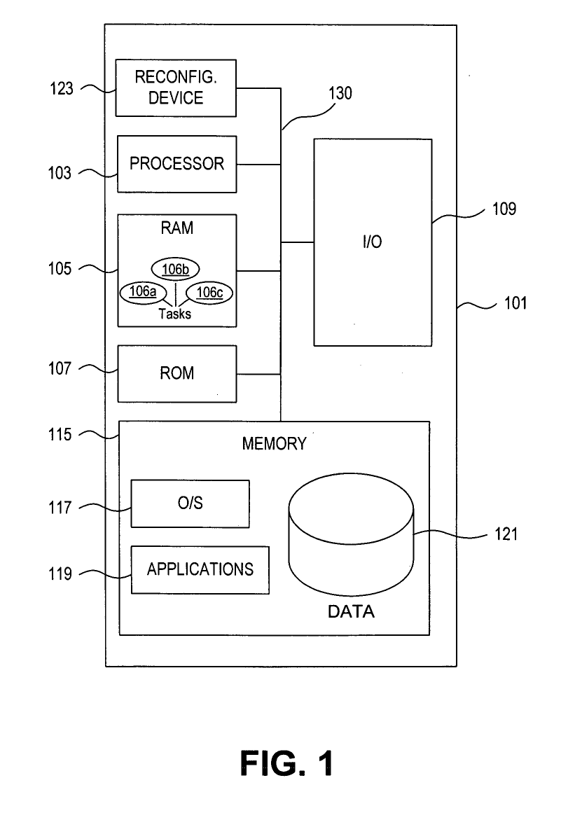

FIG. 1 illustrates a block diagram of a generic computing device 101 that may be used in accordance with certain embodiments of the invention. Device 101 may include a processor 103 for controlling the overall operation of the computing device and its associated components, including RAM 105, ROM 107, input/output module 109, and memory 115. Also shown inside the RAM 105 are applications 106a-106c, representing the application data stored in RAM memory 105 while the computer is on and corresponding software applications (e.g., software tasks) are running on the computer 101, including, for example, system applications and user applications, such as native applications or managed applications executed in a managed runtime environment. Thus, computer 101 typically includes a variety of computer readable media, and combinations of the any of the above should also be included within the scope of computer readable media.

I/O 109 may include a microphone, keypad, touch screen, and/or stylus through which a user of device 101 may provide input, and may also include one or more of a speaker for providing audio output and a video display device for providing textual, audiovisual and/or graphical output. I/O 109 may also include a user interface including such physical components as a voice interface, one or more arrow keys, joy-stick, data glove, mouse, roller ball, touch screen, or the like. Memory 115 may store software used by device 101, such as an operating system 117, application programs 119, and associated data 121. Additionally, an application program 119 used by device 101 according to an illustrative embodiment of the invention may include computer executable instructions for invoking system and/or user functionality. One or more reconfigurable hardware device 123 may also be integrated into the computer 101 and connected to the other components using a bus 130.

Device 101 may also be part of a mobile communication system. Such systems are well-known in the art to include one or more base stations communicating with one or more mobile terminals via radio communication. The device 101 may be a base station in such a system, configured to perform baseband and radio frequency processing. The device 101 may also be a mobile terminal including various other components, such as a battery, speaker, and antennas (not shown). Additionally, the memory 115 of computer 101 may be implemented with any combination of read only memory modules or random access memory modules, optionally including both volatile and nonvolatile memory and optionally being detachable. Software may be stored within memory 115 and/or storage to provide instructions to processor 103 for enabling computer 101 to perform various functions. Alternatively, some or all of computer 101 computer executable instructions may be embodied in hardware or firmware (not shown). Additionally, device 101 may be a mobile terminal configured to send and receive transmissions through various device components, such as an FM/AM radio receiver, wireless local area network (WLAN) transceiver, and telecommunications transceiver (not shown). In one aspect of the invention, mobile terminal 101 may receive radio data stream (RDS) messages. Mobile terminal 101 may be equipped with other receivers/transceivers, e.g., one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Hardware may be combined to provide a single receiver that receives and interprets multiple formats and transmission standards, as desired. That is, each receiver in a mobile terminal 101 may share parts or subassemblies with one or more other receivers in the mobile terminal device, or each receiver may be an independent subassembly.

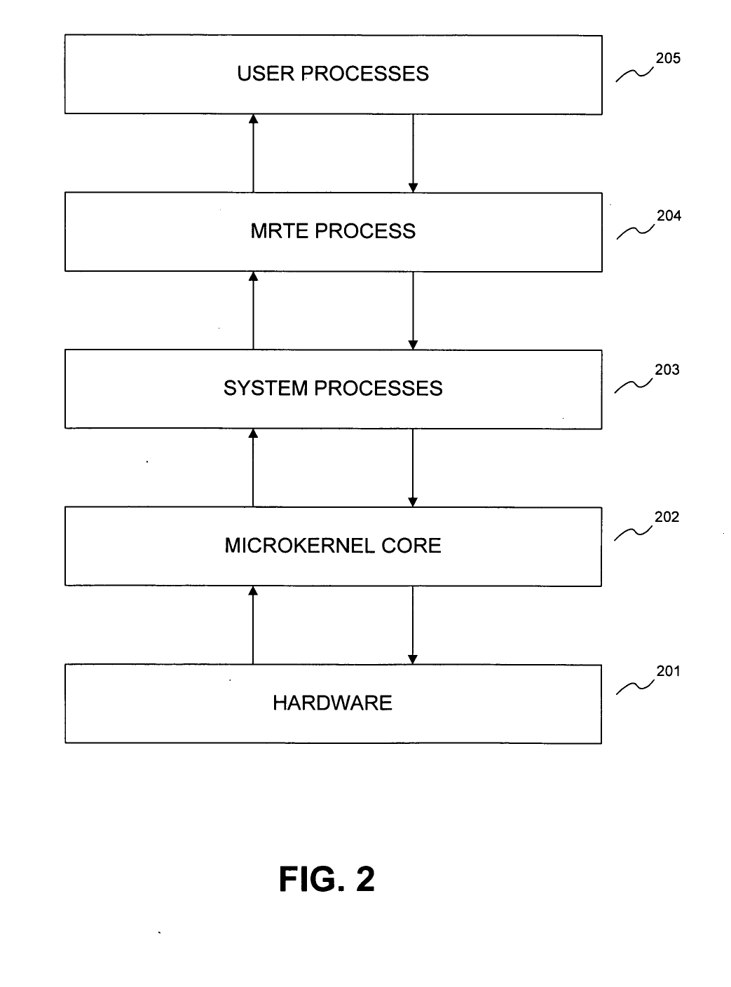

Referring to FIG. 2, a block diagram is shown illustrating the logical components of a computing device 101 configured to operate (e.g., run) a microkernel operating system. Although certain illustrative embodiments described herein refer to microkernel operating systems, it is to be understood that the present invention is not limited to microkernel systems, but may also be implemented in other conventional computer operating system environments.

Component 201 represents the hardware layer of the computing device 101, including, for example, a processor 103, one or more device memory components 105, 107, and 115, and input/output components 109. As described above, the hardware layer 201 underlies and supports all software execution in the computing environment in both microkernel system and non-microkernel operating systems.

Component 202 represents the microkernel core functionality of the operating system. The microkernel core 202 includes the processes and memory that provide basic and essential system functionality. Specifically, the microkernel core 202 may include system-critical memory and may support operating system services such as thread management, interprocess communication (IPC), and address space and memory management. The functionality of the microkernel core 202 may be designed so that the core 202 provides the minimum possible functionality, in order to gain potential advantages related to stability and security, while also providing support for higher-level system components to perform their respective functions and interact with one another. The microkernel core 202 may typically operate in kernel mode, while both non-microkernel core system functionality (e.g., external server processes) and all other user processes 203-205 are operated in user mode.

Component 203 represents the non-core functionality of the microkernel operating system. This non-core functionality of the microkernel, or extended functionality, may be provided by several different external servers, or different software processes executing separately from the kernel core process(es). The extended functionality 203 of the microkernel system may be designed so that each different external server executes its own process on the system, dedicated to providing a specific operating system functionality. For example, component 203 may include a file system external server, a communication external server, a networking external server, a display external server, etc., each of which operate as separate processes on the computing device 101. In this example, each of the external servers 203 may invoke the interprocess communication and other basic functionality provided by microkernel core 202 to receive client requests and return data, perform their respective system operations, and communicate with the other external servers via the core interprocess communication.

Component 204 represents the managed runtime environment (MRTE) process. It should be understood that all microkernel operating systems need not include a managed runtime 204, and could nonetheless support the same user functionality by employing native applications (i.e., applications which directly invoke operating system functions and components 203). However, an MRTE may provide advantages for developing code and executing software in certain systems. Specifically, the MRTE may control how the executable code is loaded into the memory 105 of the device 101, where the application data is stored, and how methods in various MRTE and system libraries are invoked during execution of the application code. In embodiments where a microkernel operating system is used, both the external servers 203 and MRTE 204 may run within the user mode on the computing device 101.

As an example, the MRTE 204 may include a Java Virtual Machine (JVM) that allows native user applications to be written in a programming language (e.g., Java), which are then interpreted/compiled and executed on the system by the MRTE component 204. It should be understood that the embodiments described herein are not limited to Java and JVM runtime environments, but may be used with other application programs and MRTEs, such as Microsoft's C#, Visual Basic NET, C++ NET, and the Microsoft NET Common Language Runtime (CLR) environment executing on a Microsoft Windows or Linux operating system. Additionally, in a microkernel operating system, the MRTE 204 may perform optimization and management of user applications before and while the applications are executed on the system. During execution, the MRTE 204 may coordinate the access to the external servers 203, for example, via system libraries or application programming interfaces (APIs) depending on the extended functionality required by the application. Specifically, the MRTE 204 may perform function calls using a MRTE-Native system interface, such as the Java Native Interface mechanism, to invoke the extended functionality 203 of the operating system.

Component 205, the highest-level component in this diagram, represents user applications executed on the computing device 101. In this example, a user application 205 accesses the operating system functionality 202 and 203 via the MRTE component 204, and may therefore take advantage of the application management, memory management, and optimization functions provided by the MRTE 204. In certain other embodiments, not shown in FIG. 2, a user application 205 may directly invoke functionality within the operating system 202 and 203, for example, by performing calls to system libraries or APIs of external servers 203. These so-called native applications may therefore be responsible for handling on their own the tasks typically performed by the MRTE component 204 for managed applications.

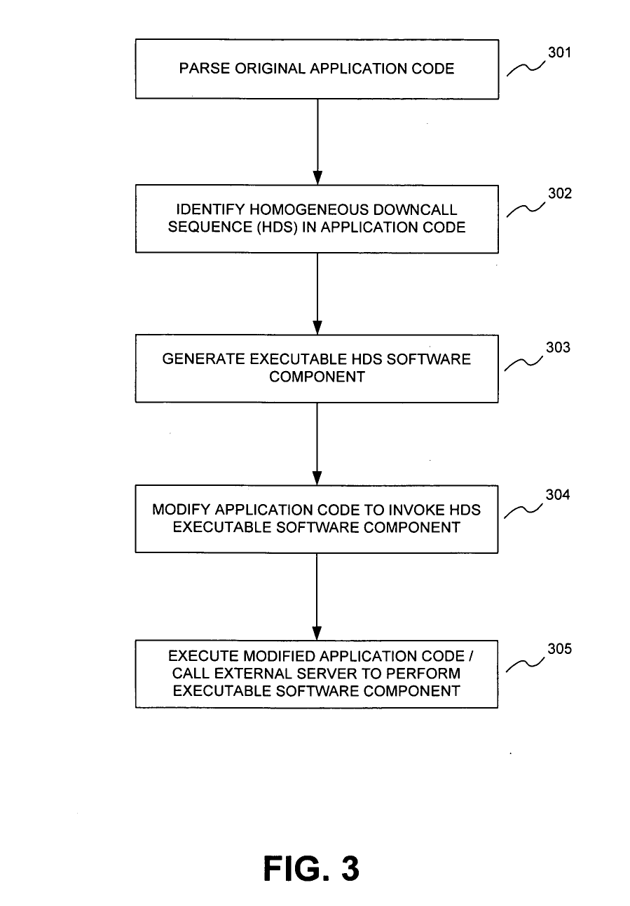

Referring to FIG. 3, a flow diagram is shown illustrating the execution of user application code within an operating system, in accordance with aspects of the present invention. As mentioned above, the operating system in this example may be a microkernel system; however, the disclosed techniques relating to optimization of system function calls are not limited to microkernel systems, but may be applied with any conventional computer operating system.

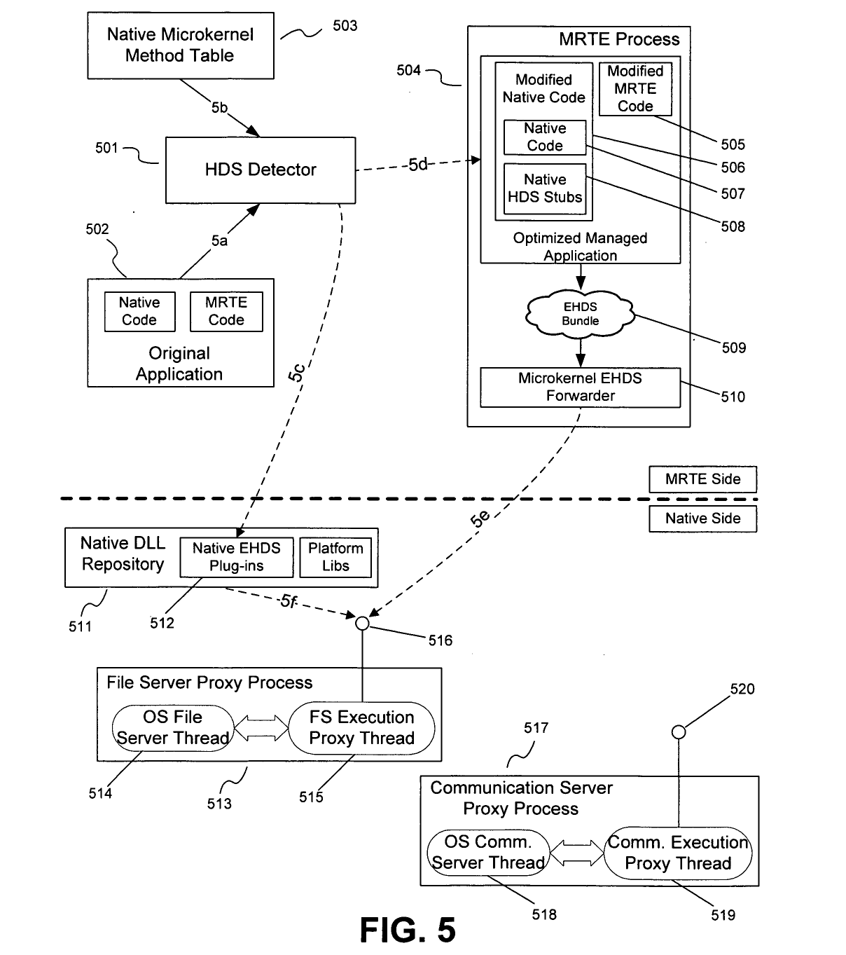

In step 301, computer source code (e.g., a block of code of a computer programming language such as JavaScript or C++) from a user application is received and parsed. Step 301 may occur during the process of executing the user application, or may instead occur beforehand as a way of saving time at execution. Additionally, as described below in FIG. 5, the source code parsing may be performed by a software component (e.g., homogeneous downcall sequence (HDS) detector 501) which may be implemented as a separate user process, system process, or may be incorporated into the functionality of the MRTE.

In step 302, the parsed application source code is analyzed to identify one or more homogeneous downcall sequences. A homogeneous downcall sequence (HDS) is a sequence of multiple system function calls within an application program which occur at approximately the same point in the execution of the program and which are directed to the same operating system process. For example, two method calls within an application program that invoke the same microkernel external server function, and which are (a) in sequential code instructions (i.e., with no intervening application code between the two function calls), or (b) nearly sequential code instructions (e.g., only a few unrelated application code instructions intervening between the two function calls), would likely be a homogeneous downcall sequence. Thus, an HDS may represent multiple sequential interactions with the same external server in component 203. For example, an application program which performs a recursive copy of a directory in the file system of a computer 101 running in a microkernel operating system would likely perform several similar function calls to the external server process corresponding to the file system server of the microkernel. In this example, a control loop (e.g., “for” loop, “while” loop, etc.) in the program source code may invoke server functions to open, read, create, and write a set of files from a source location to a destination location in the file system. As another example, the following sample application source code may be analyzed in step 302 to identify an HDS of calls to system functions:

```
public double aNativeLoopMethod( ){
double f=0;
for (int i=0;i<100;i++){
      myExtServer.method1(i);
  f=aFunction(i);
  myExtServer.method2(f);
}
return f;
}//aNativeMethod
```

In this example, each individual invocation of the myExtServer.method1 and myExtServer.method2 functions on the external server represents a downcall, and the sequential request-response downcalls to the microkernel external server myExtServer for performing the iterative method1 calls may constitute a homogeneous downcall sequence. In other examples, multiple HDSs may be identified in a single application program, such as different HDSs directed to the same external server at different times during the execution of the program, as well as different HDSs directed to different external servers of the microkernel. Additionally, it may be possible to identify HDSs in non-managed native applications by detecting methods in the application source code that directly invoke an external server (e.g., in a microkernel system) or the core system APIs (e.g., in a conventional operating system).

In step 303, an executable HDS software component (EHDS) may be generated for each HDS identified in step 302. The EHDS may be an ad hoc component, for example, a server plug-in, created during or just prior to the execution of the application program. The EHDS may be designed/configured to provide the same or similar functionality to its associated HDS. For example, an EHDS component corresponding to a sequence of request-response function calls in a control loop might include an optimized set of similar function calls with an ad-hoc generated infrastructure to pipe the output of the early function calls in the sequence as input into the later function calls, thus performing the same or similar functionality that would be performed by the execution of the HDS in its original form. Thus, the code sample function discussed in step 302 above may be transformed into the following function in step 303:

public double aNativeLoopMethod( ){
return HDS1_stub.execute( );
}//aNativeMethod

### In this example, HDS1_stub is a new class generated by the HDS detector 501, and the execute( ) function executes as a native method as further described below.

The generated EHDS may be stored locally so that it may be accessible to the microkernel external server for execution at the appropriate time. In one example, the EHDS may be stored within the process space of its associated microkernel external server process, thus avoiding one level of context-switching. Alternatively, a library of native EHDS plug-ins may be stored, for example, in a native DLL repository with a platform library. Thus, many different EHDSs may be stored in a single library or repository, including EHDSs for different applications and EHDSs associated with different external servers.

In step 304, the source code from the original application program is modified, prior to its execution within the operating system. It should be understood that although this example refers to source code modification, the inventive techniques disclosed apply to modification of any instructions to be executed on a computing device (e.g., object code, compiled/interpreted code, executable code, and copies of the any of the original instructions made prior to modification). The code modification, described in detail below with reference to FIG. 5, may be performed in general to ensure that the newly generated EHDS is invoked at an appropriate time during the execution of the application program, and that the sequence of downcalls in the HDS is not invoked. For example, a portion of MRTE (managed) source code from an application program may be modified so that each detected HDS is removed from the source code, and replaced with a call to a native method of the newly-generated respective EHDS. It should be noted that original instructions (e.g., application code) may include both MRTE (or managed) code along with native (or un-managed) code. Thus, in step 304 either or both of the MRTE and native instructions (e.g., source code) from the application program may be modified to replace any identified HDSs with references to their corresponding newly-generated EHDSs. In step 305, the modified application code is executed. As described in greater detail in reference to FIG. 5, the application program itself may be executed natively or via the MRTE, in conjunction with the execution of its associated EHDSs by the native system process.

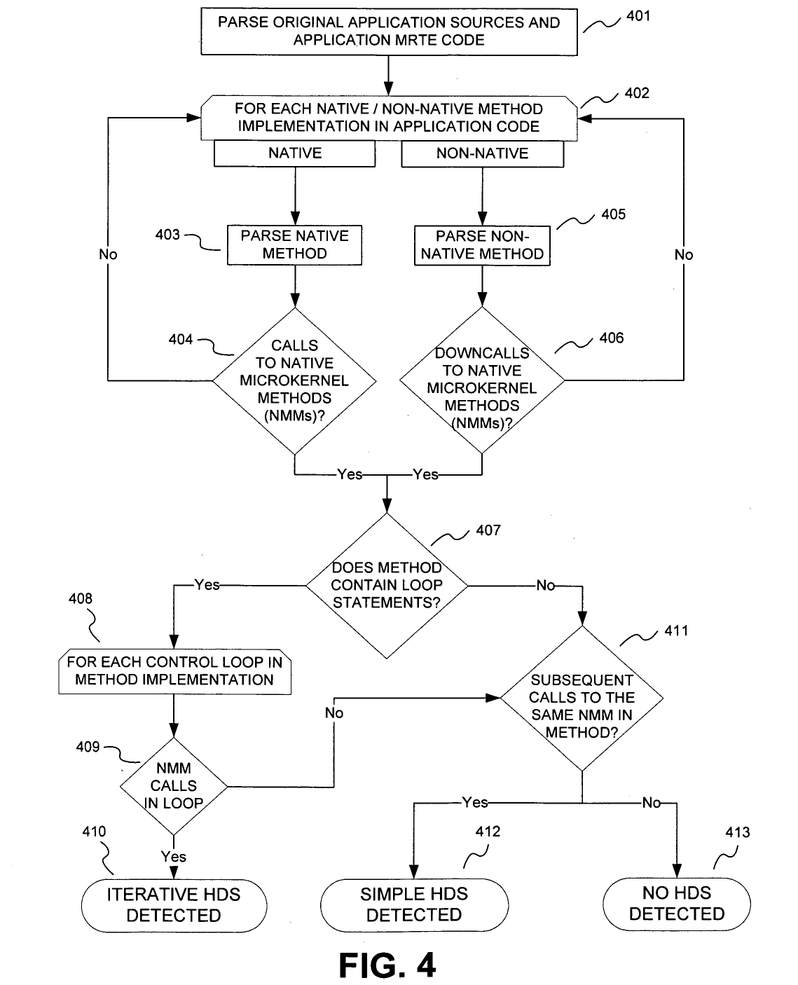

Referring to FIG. 4, a flow diagram is shown illustrating the detection of HDSs within a block of program source code. As described below, the logical steps discussed in this example may be performed by a separate HDS detector 501 component process. HDS detector functionality may also be embedded into another application with access to the native application source code., for example, the MRTE component in the case of a managed application consisting of MRTE code. In other words, in certain embodiments, the HDS detector 501 may require source code access and thus might not be able to perform optimizations during execution of native code. However, in the case of managed code, optimizations may be performed along with the code execution, for example, by an embedded HDS detector 501 during the interpretation and dynamic compilation phases in a just-in-time (JIT) virtual machine.

In step 401, the source code of the original application program, including both native application code and MRTE code, may be parsed by the HDS detector 501. The parsing in step 401 may occur just prior to or as part of the execution, for a managed code application. Alternatively, for managed or native applications, the parsing may occur earlier, for example, during source code creation, compilation, or interpretation.

In step 402, the parser functionality of the HDS detector 501 iterates through each native and non-native method in the application source code. If an application method for an iteration of step 402 is a native method, then the native method is parsed by the HDS detector 501 in step 403, and then analyzed in step 404 to determine if the native method contains one or more calls to any native microkernel methods (NMMs), such as a system library function or API method supported by one of the microkernel external servers. If the native application method contains no NMM calls (404:No), then no further examination or modification of that method need be performed at this time. Similarly, if the application method for an iteration of step 402 is a non-native method, then the non-native method is parsed by the HDS detector 501 in step 405, then examined in step 406 to determine if it contains one or more downcalls, that is, one or more native calls to microkernel external servers to invoke the extended functionality provided by the external server.

Having reached step 407, an application method has been identified as having one or more calls to a native microkernel method (NMM). Steps 407-413 in this example will determine whether or not an HDS is present in this application method, and if so, an HDS type may also be determined which may be useful for later generation of the EHDS and modification of the application code as described in FIG. 3. In step 407, the source code of the application method is analyzed to determine whether one or more control loops (e.g., “for” loops, “while” loops, etc.) are present in the method. If so (407:Yes), the source code within the control loop(s) is analyzed to determine whether a NMM call occurs within that loop in step 408. If an NMM call is identified within one of the control loops, the HDS detector 501 may determine that this is likely an HDS, and may then store/return data corresponding to an indication of an iterative HDS in step 410.

If no NMM calls are present in the control loop(s) (409:No), or if the application source code contains no more control loops (407:No), then an HDS might still occur within the method as a result of multiple function calls to the same NMM, or to the different NMMs supported by the same microkernel external server. In certain implementations, NMM calls that are not in an iterative loop may be required to be adjacent to each other in the application source code before the code segment is identified as an HDS. In contrast, this implementation might identify an HDS in an iterative loop even if there are intervening lines of code in the loop (e.g., code involving only automatic variables with scope limited to the loop itself, or variables only to be used within the loop or the HDS). Two sample functions from which an HDS may be identified in this illustrative implementation are shown below:

```
public double aNativeLoopMethod( ){
double f=0;
for (int i=0;i<100;i++){
  myExtServer.methd1(i);
  f=aFunction(i);
  myExtServer.method2(f);
}
return f;
}//aNativeMethod
public double aNativeSimpleMethod( ){
double f=0;
int i=100 ;
myExtServer.methd1(i);
f=aFunction(i);
myExtServer.method2(f);
myExtServer.method3( );
f=myExtServer.method4(i);
return f;
}//aNativeMethod
```

Thus, in step 411, if a subsequent call to the same (or a related) NMM is identified in the application method (411:Yes), then the HDS detector 501 may store/return data indicating a simple HDS in step 412. In this example, a simple HDS may simply refer to an HDS based on different sequential function calls in the application code, rather than a single function call in an iterative loop. Alternatively, if no NMMs are executed in control loops, and if no subsequent calls are found to the same (or a related) NMM (411:No), then the HDS detector 501 may determine that no HDS exists in the current application method.

Referring to FIG. 5, a schematic block diagram is shown including various components and component communication in an illustrative system for optimizing calls to a microkernel external server, according to certain aspects of the invention. Specifically, FIG. 5 provides examples of certain illustrative embodiments with greater detail than the more general logical steps shown in FIG. 3 for executing a sequence of operating system calls. In this example, various software and data components are represented by numbers 501-520, while communication between the various components are represented by letters 5a-5f.

Communication pathway 5a represents the transmission from the application 502 to the HDS detector 501 of the application source code to be executed. In examples like the one shown in FIG. 5, the original application 502 is not a pure native application, that is, it does not directly access the microkernel external servers 513 and 517 when executed. Rather, in this example, the original application 502 executes using a managed runtime environment (MRTE) process 504. Thus, the communication pathway 5a need not be an interprocess communication, but may instead simply involve the HDS detector process 501 retrieving the application source code from the appropriate location in the memory 115 of the computing device 101. Upon retrieving the application source code, which includes both native code and MRTE code in this example, the HDS detector 501 may parse and analyze the code, for example, using similar techniques to those described above in reference to FIG. 4.

An additional aspect of HDS detection in this example relates to the native microkernel method table (NMMT) 503. The NMMT 503 may be generated based on the collective API/function library data for the microkernel external servers 513 and 517, to catalog and index each NMM that could be invoked by the application source code. Specifically, the NMMT 503 may contain data to retrieve the native-code implementation, as well as a unique identifier for the associated external server, for each of the MRTE native-methods that invoke native microkernel servers. In certain implementations, the interfaces provided by the original server thread for the proxy process (e.g., 513 and 517) may be used to generate and/or update the NMMT 503. Thus, communication pathway 5b may represent the HDS detector 501 retrieving the description, native-code implementation, and/or external server identifier for a specific NMM detected within the application source code.

Subsequently, as described generally above in step 303 of FIG. 3, the HDS detector 501 may produce native EHDS plug-ins 512 which correspond to the identified HDSs in the application source code. As shown by communication pathway 5c, the native EHDS plug-ins 502 may be stored in a common native DLL repository 511. In order to realize additional performance advantages related to execution of the EHDS plug-ins 512, real-time access to the plug-ins 512 might be guaranteed by the microkernel system, for example, by using shared memory for EHDS plug-in storage, or by using static ROM areas for EHDS plug-ins corresponding to well-known HDSs detected in performance-critical class libraries of the MRTE 504. In other examples, the generated native EHDS plug-ins 512 may be stored in a proxy-specific repository, managed locally by the proxy process of the microkernel external server 513 or 517, which may also result in performance advantages for attaching and executing the EHDS plug-ins 512.

Additionally, as generally described above in step 304 of FIG. 3, the HDS detector 501 may modify the application source code so that the EHDS plug-ins are appropriately invoked, rather than the HDSs in the original source code. In this example, the HDS detector 501 produces a variant of the original application source code and transmits the modified code to the MRTE process 504 via communication pathway 5d. In certain embodiments in which an MRTE process 504 is used to manage the execution of the application program, the HDS detector 501 may transmit the modified source code to the MRTE 504 in several distinct data components. For example, as shown in FIG. 5, the modified MRTE source code 505 includes an instrumented variant of the original MRTE code, in which each detected HDS is replaced by a call to a native method of an ad-hoc generated native HDS stub 508. The set of ad-hoc generated native HDS stubs 508, corresponding to the set of identified HDSs, may be transmitted to the MRTE 504 and stored with the native code 507 which together form the modified native code 506.

Each native HDS stub 508 may invoke the microkernel EHDS forwarder 510 in the MRTE 504, and provide the EHDS forwarder 510 (e.g., as a set of arguments to a function call) a unique identifier for the external server of the EHDS and a set of HDS-dependent I/O parameters. The identifier enables the EHDS forwarder 510 to forward the I/O parameters to the appropriate microkernel server execution proxy 515 or 519 for execution of the EHDS. Additionally, the EHDS forwarder 510 may be responsible for transferring control to the identified proxy process 513 or 517. Thus, in this example, communication pathway 5e represents the EHDS forwarder 510 sending the appropriate parameters to the file server execution proxy 515 and transferring control to the execution proxy 515, in order to execute the EHDS within the related microkernel server process 513.

The communication pathway 5f represents the retrieval of the native EHDS plug-in 512 from the repository 511, so that the execution proxy 515 may execute the EHDS. The native EHDS plug-in 512 may be dynamically or statically loaded within the resource-specific execution proxies 513 and 517, so that the EHDS may be executed as-a-whole on the native side and within the file server proxy process 513. As mentioned above, the native EHDS plug-in may contain all the request-response interactions with the target microkernel server requested by a certain HDS, and the parameters needed to invoke the EHDS plug-in may be received from the EHDS forwarder 510. Thus, the execution proxy component 515 may execute the EHDS plug-in 512 on behalf of the MRTE 504. Since this functionality is called by a thread 515 that is executed within the same process 513 as the original external server thread 514, unnecessary context switching for multiple NMM calls may potentially be avoided. Thus, in FIG. 5, the bi-directional arrows connecting the proxy threads 515 and 519 with their respective server threads 514 and 518 may represent an optimized inter-thread communication mechanism, which may communicate more efficiently than the inter-process communication used in conventional techniques.

In other examples, a similar approach may be adopted for Java Native Interface (JNI) implementations of third-party Java classes. For example, HDS detector 501 may act directly on the C++ native code of the JNI wrappers, in order to identify the sequences of homogeneous calls to system servers. In this example, the adoption of an ahead-of-time optimization strategy may be required, since the native code might not be managed but may instead be directly compiled into machine code and executed in the native platform.

The HDS-detection and code-bundling techniques described herein may be implemented into a Java Hotspot Implementation compiler, thereby potentially enabling runtime dynamic optimization of Java code.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. A method, comprising:
receiving a first set of instructions to be executed on a computing device;
identifying a plurality of homogeneous function calls in said first set of instructions;
creating an executable software component operable to perform functionality corresponding to the plurality of homogeneous function calls; and
generating a second set of instructions based on said first set of instructions, wherein said second set of instructions does not comprise the identified plurality of homogeneous function calls and does comprise a reference to said executable software component, and wherein an execution of the second set of instructions on the computing device requires said computing device to perform fewer context switches than an execution of the first set of instructions on the computing device.

2. The method of claim 1, wherein said first set of instructions are part of a native application, said native application executing function calls directly on an operating system function.

3. The method of claim 1, wherein said first set of instructions are part of a managed runtime environment application.

4. The method of claim 1, further comprising executing the second set of instructions by invoking the executable software component, said invocation comprising performing no more than two context switches.

5. The method of claim 1, further comprising executing the second set of instructions by identifying and invoking a server execution proxy, wherein said server execution proxy comprises one or more threads running within an operating system process.

6. The method of claim 5, wherein said operating system process comprises an external server of a microkernel operating system.

7. The method of claim 5, wherein the executable software component is a native component that is statically loaded within the server execution proxy.

8. The method of claim 5, wherein the executable software component is a native component that is dynamically loaded within the server execution proxy.

9. The method of claim 1, wherein identifying the plurality of homogeneous function calls comprises identifying an operating system function call within a control loop in said first set of instructions.

10. The method of claim 1, wherein identifying the plurality of homogeneous function calls comprises identifying multiple different operating system function calls within a single method of said first set of instructions.

11. An electronic device, comprising:
a processor controlling at least some operations of the electronic device;
a memory storing computer executable instructions that, when executed by the processor, cause the electronic device to perform a method for executing instructions on a computing device, the method comprising:
receiving a first set of instructions to be executed on a computing device;
identifying a plurality of homogeneous function calls in said first set of instructions;
creating an executable software component operable to perform functionality corresponding to the plurality of homogeneous function calls; and
generating a second set of instructions based on said first set of instructions, wherein said second set of instructions does not comprise the identified plurality of homogeneous function calls and does comprise a reference to said executable software component, and wherein an execution of the second set of instructions on the computing device requires said computing device to perform fewer context switches than an execution of the first set of instructions on the computing device.

12. The electronic device of claim 11, wherein said first set of instructions are part of a native application, said native application executing function calls directly on an operating system function.

13. The electronic device of claim 11, wherein said first set of instructions are part of a managed runtime environment application.

14. The electronic device of claim 11, wherein the method further comprises executing the second set of instructions by invoking the executable software component, said invocation comprising performing no more than two context switches.

15. The electronic device of claim 11, wherein the method further comprises executing the second set of instructions by identifying and invoking a server execution proxy, wherein said server execution proxy comprises one or more threads running within an operating system process.

16. The electronic device of claim 15, wherein said operating system process comprises an external server of a microkernel operating system.

17. The electronic device of claim 15, wherein the executable software component is a native component that is statically loaded within the server execution proxy.

18. The electronic device of claim 15, wherein the executable software component is a native component that is dynamically loaded within the server execution proxy.

19. The electronic device of claim 11, wherein identifying the plurality of homogeneous function calls comprises identifying an operating system function call within a control loop in said first set of instructions.

20. The electronic device of claim 11, wherein identifying the plurality of homogeneous function calls comprises identifying multiple different operating system function calls within a single method of said first set of instructions.

21. One or more computer readable media storing computer-executable instructions which, when executed on a computer system, perform a method for executing application code on a microkernel operating system, the method comprising:
receiving a first set of application instructions to be executed on a microkernel operating system;
identifying one or more homogeneous downcall sequences (HDS) in said first set of application instructions;
creating an associated executable HDS software component (EHDS) for each of the one or more identified HDSs; and
generating a second set of application instructions based on said first set of application instructions, wherein said second set of application instructions comprises a reference to each EHDS, wherein each reference is added to the second set of application instructions instead of the associated identified HDS, and wherein an execution of the second set of application instructions on the microkernel operating system requires fewer context switches than an execution of the first set of application instructions on the microkernel operating system.

22. The computer readable media of claim 21, wherein identifying the one or more HDSs comprises parsing said first set of application instructions and comparing said parsed instructions to items in a native microkernel method table.

23. The computer readable media of claim 21, wherein the method further comprises executing the one or more EHDSs by identifying an external server configured to provide the functionality of the one or more HDSs and invoking a server execution proxy associated with said external server.

24. The computer readable media of claim 23, wherein the server execution proxy comprises one or more process threads executing within a process running the external server.

25. The computer readable media of claim 24, wherein the EHDSs are native components that are statically loaded within the server execution proxy.

26. The computer readable media of claim 24, wherein the EHDSs are native components that are dynamically loaded within the server execution proxy.

27. The computer readable media of claim 21, wherein identifying the one or more HDS comprises identifying a microkernel method call within a control loop in said first set of application instructions.

28. The computer readable media of claim 21, wherein said first set of application instructions comprises source code to be executed by a managed run time environment.

29. The computer readable media of claim 21, wherein the method further comprises executing the one or more EHDSs on the microkernel operating system by performing only two context switches for each EHDS executed.

30. An electronic device, comprising:
means for receiving a first set of instructions to be executed on a computing device;
means for identifying a plurality of homogeneous function calls in said first set of instructions;
means for creating an executable software component operable to perform functionality corresponding to the plurality of homogeneous function calls; and
means for generating a second set of instructions based on said first set of instructions, wherein said second set of instructions does not comprise the identified plurality of homogeneous function calls and does comprise a reference to said executable software component, and wherein an execution of the second set of instructions on the computing device requires said computing device to perform fewer context switches than an execution of the first set of instructions on the computing device.

31. The electronic device of claim 30, further comprising:
means for executing the second set of instructions comprising identifying and invoking a server execution proxy, wherein said server execution proxy comprises one or more threads running within an operating system process.
